(19) United States
(12) Patent Application Publication
(10) Pub. No.: US 2009/0199240 A1
(43) Pub. Date: Aug. 6, 2009

(54) Computer System Capable of Instantly Showing Electronic Program Guide and Method for Using the Same

(75) Inventors: Chun-Kai Chan, Taipei (TW); Li-Hsiang Liao, Taipei (TW); Ya-Shu Juang, Taipei (TW); Chih-Hao Liang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTeK COMPUTER INC., Taipei (TW)

(21) Appl. No.: 12/267,751

(22) Filed: Nov. 10, 2008

(30) Foreign Application Priority Data
Feb. 1, 2008 (TW) 97104400

(51) Int. Cl. H04N 5/445

(52) U.S. Cl. 725/39

(57) ABSTRACT

The invention relates to a method for showing an electronic program guide (EPG) on a computer screen. The computer has EPG data, a desktop application and a TV play program. The method includes the following steps. First, the desktop application program is launched, and an application window is displayed on the screen. Then, the EPG data is retrieved, and program information which is played is shown in the application window. Then, a message showing that the program information is clicked is received. Afterward, the TV play program is launched, and the TV program corresponding to program information is played.

### BACKGROUND OF THE INVENTION

1. Field of the Invention

The invention relates to a method for showing an electronic program guide (EPG) on a computer screen and, more particularly, to a method for showing the EPG instantly and launching television (TV) play program via a desktop application to watch programs.

2. Description of the Related Art

Nowadays, the Internet is developed very well. Via the assistance of electronic devices, a user may watch TV programs via a computer without a television. A method for watching TV programs on a computer screen includes the steps of launching a TV play program in a computer and receiving digitized “TV signals” via a wired or wireless network of a digital TV system. Thus, the user may watch digital TV programs.

For a user, if he wants to know the contents of played programs, he usually directly launches the TV play program. After he browses through all channels, he can know about programs played in various channels. That is, only after he clicks on a channel, he can get relative program information of the channel. To allow users to know about digital TV program information, some digital television system suppliers or TV channel chamber of commerce provides an electronic program guide (EPG) service. Via a network, a digital TV program timetable is transmitted everyday or every week. However, users still need to launch the TV play program to obtain the digital TV program information.

In addition, in the past, after a user chooses to watch a program of some channel, he cannot know the content of programs played in other channels at the same time. Therefore, he may miss his favorites program. Certainly, the conventional TV play program may show the content of the programs played in other channels in a corner of a window when playing a program. However, for the user, he still needs to make a TV play program launched to obtain relative program information. If a user only wants to know about program information, he has to launch the TV play program, which wastes operating resource of the computer to a certain extent.

### BRIEF SUMMARY OF INVENTION

The invention provides a method for showing the EPG instantly and a computer thereof.

The method for showing the EPG in a computer screen disclosed in the invention is performed in a computer having EPG data, a desktop application and a TV play program. The method includes the following steps. First, the desktop application is launched, and an application window is shown on the screen. Then, the EPG data is retrieved, and played program information is shown in the application window. Afterward, a message showing that the program information is clicked is received. Then, the TV play program is launched, and the TV program corresponding to the program information is played.

In addition, the computer of the invention includes a memory device, a screen and a processing device. The memory device stores a desktop application, a TV play program and EPG data. The screen is used to show an operating system (OS) desktop. The processing device is used to launch the desktop application to generate an application window on the screen and retrieve EPG data to show program information which is played in the application window. The processing device receives a message showing that program information is clicked, and thus it launches the TV play program and plays the TV program corresponding to the program information on the screen.

The desktop application capable of showing the EPG and the computer thereof are further described with the drawings hereinbelow.

These and other features, aspects, and advantages of the present invention will become better understood with regard to the following description, appended claims, and accompanying drawings.

### BRIEF DESCRIPTION OF THE DRAWINGS

FIG. 1 is a computer capable of showing an EPG of one embodiment of the invention;

FIG. 2 is a schematic diagram showing the screen of one embodiment of the invention; and

FIG. 3 is a flow chart showing the operating steps of showing an EPG on the screen of the computer according to one embodiment of the invention.

### DETAILED DESCRIPTION OF THE EMBODIMENTS

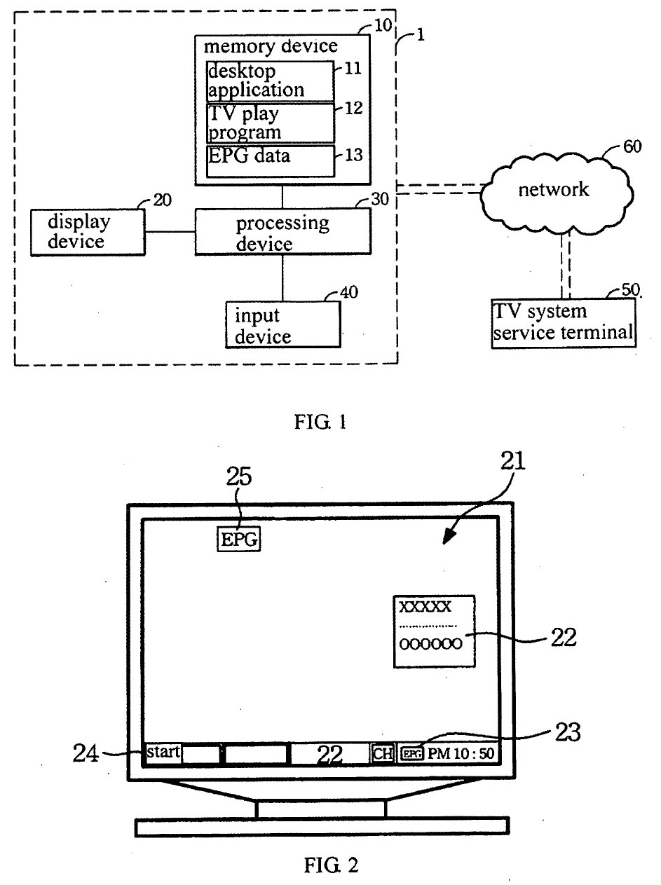

FIG. 1 and FIG. 2 are schematic diagrams showing a computer 1 and a screen 21 capable of showing an EPG according to one embodiment of the invention. In the embodiment, the computer capable of showing the EPG includes a memory device 10, a display device 20, a processing device 30 and an input device 40.

The memory device 10 stores a desktop application 11, a TV play program 12 and EPG data 13.

The display device 20 can show the screen 21 shown in FIG. 2. An application shortcut 25 of the desktop application 11 is shown on the screen 21. When the application shortcut 25 on the desktop is clicked, the computer launches the desktop application 11 and generates an application window 22 on the screen 21. If the user wants to hide the application window 22 on the screen 21, a user may click via an input device 40 to allow a program shortcut icon 23 of the desktop application program 11 to be shown at the taskbar 24 of the screen 21.

After the desktop application 11 is launched, it retrieves the EPG data 13 stored in the memory device 10 and makes played program guide shown in the application window 22. The program guide may be set to show program lists of different channels every few seconds, or it may be set to instantly show the played program guides of some constant channels according to needs of users.

When a user wants to watch a program of the application window 22, he may directly click the program guide in the application window 22 via the input device 40. At that time, the processing device 30 receives a message showing that program information is clicked, and then it launches the TV play program 12 and plays the TV program corresponding to the program information.

In one embodiment, the computer is connected to a computer system service terminal 50 to update the EPG data via a network 60. If the relative updating function is performed via the TV play program 12, after the TV play program 12 is launched, the EPG data is updated automatically. If the relative updating function is performed via the desktop application 11, after the desktop application 11 is launched, the relative updating process is performed automatically.

In one embodiment, the computer 1 may be a set-top box or a game besides a desk-top or a notebook computer. The input device 40 may be a mouse, a keyboard or a remote controller and so on. The processing device 30 may be a central processor.

The desktop application 11 may be designed to be a resident program. When the computer 1 is booted, the computer automatically launches and makes the program shortcut icon 23 reside in the taskbar 24. In addition, if a user considers that a resident program occupies the resource of the computer, he may set an application shortcut 25 on the screen 21 in the process of installing the desktop application 11. When the user wants to know about the program information, he may click the application shortcut 25 via the input device 40 to launch the desktop application 11 and show the application window 22 on the screen 21.

In addition, the TV system service terminal 50 may be a channel supplier or a website supplying TV programs besides cable TV supplier supplying digital TV programs, and it provides relative EPG data as well as various digitized electronic programs. As for updating the EPG data, a user may set when to update. For example, he may set to update the EPG data every week or every few days, or he may set to update the EPG data online when the program (such as the desktop application or the TV play program) is launched.

Furthermore, the application window 22 may be minified or magnified to any size. When a user clicks the application window 22 via the input device 40, he may make the stored EPG data 13 retrieved, and all program list may be shown in the window. The program timetable of a specific channel or programs played at a specific time of all channels may be searched in the program list. The arrangement of the program list may be changed according to the needs of users and may be classified according to the data, time, channel and program.

A user may mark the loved TV program on all program list or the application window 22, and he may set the computer 1 to remind him actively via an alarm clock before the set TV program is played. The user also may set a program keyword in the all program list. When the keyword appears on the updated EPG data, a dialogue window is shown on the screen 21 to inform the user and allow a user to mark the program.

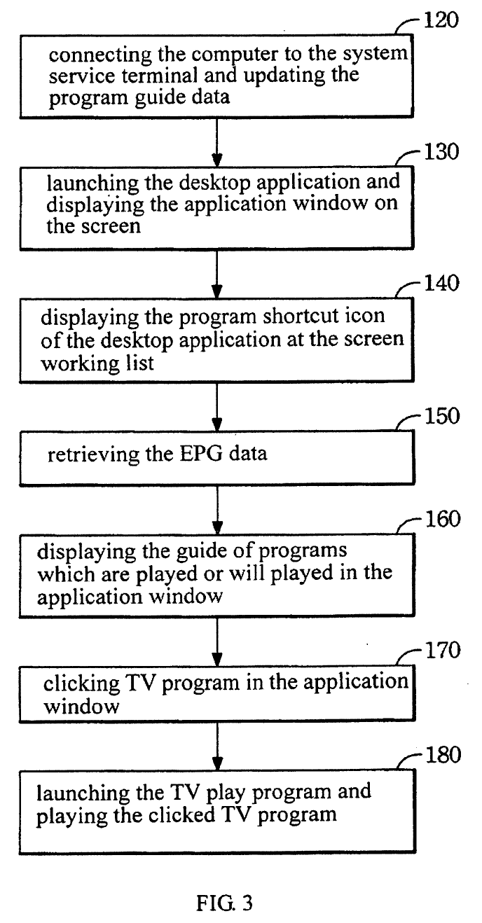

In addition, FIG. 3 is a flow chart showing the method for showing the EPG on a screen of a computer according to one embodiment of the invention. The method includes the following steps.

In the step 120, the computer is connected to a TV system service terminal 50 via the network 60 to update the EPG data. If the relative updating function is performed via the TV play program 12, after the TV play program 12 is launched, it automatically update the EPG data. If the updating function is performed by the desktop application 11, after the desktop application 11 is launched, it automatically performs the relative updating operation.

In the step 130, the desktop application 11 is launched, and an application window 22 is shown on the screen.

In the step 140, a program shortcut icon 23 of the desktop application 11 is shown at the OS taskbar 24 of the computer.

In the step 150, the EPG data 13 is retrieved.

In the step 160, played program information is shown in the application window 22.

In the step 170, a message showing that program information is clicked is received.

In the step 180, the TV play program 13 is launched and the TV program corresponding to the program information is played.

The step 120 may be provided between any two steps.

The invention has many advantages. First, a user only needs to use the desktop application 11 provided in the embodiment of the invention, he can know about the TV programs which are played or will be played later from the application window 22 on the screen 21 anytime. He does not need to launch the TV play program 12 additionally and stop the original operation to switch the window.

In addition, the desktop application 11 provided by the embodiment of the invention occupies less resource of the computer than the TV play program 12. Therefore, if a user wants to know about the programs which are played or will be played, he only needs to launch the desktop application 11 of the invention, and he does not need to launch the large TV play program 12.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for showing an electronic program guide (EPG) on a screen of a computer, wherein the computer has EPG data, a desktop application and a television (TV) play program, the method comprising the steps of:
launching the desktop application and displaying an application window on the screen;
retrieving the EPG data;
displaying program information which is played in the application window;
receiving a message that the program information is clicked; and
launching the TV play program and playing a TV program corresponding to the program information.

2. The method according to claim 1, further comprising the steps of:
connecting the computer to a TV system service terminal via a network; and
updating the EPG data.

3. The method according to claim 1, wherein the desktop application is a resident program.

4. The method according to claim 1, further comprising the step of displaying a program shortcut icon of the desktop application at an operating system (OS) taskbar of the computer.

5. A computer having a TV play program, the computer comprising:
a memory device storing a desktop application and EPG data;
a screen displaying an OS desktop; and
a processing device for launching the desktop application to generate an application window at the screen and retrieve the EPG data, wherein the playing program information is displayed in the application window;
when the processing device receives a message showing that the program information is clicked, it launches the TV play program and plays a TV program corresponding to the program information at the screen.

6. The computer according to claim 5, wherein the processing device is capable of being connected to a TV system service terminal via a network to update the EPG data.

7. The computer according to claim 5, wherein the desktop application is a resident program.
